(19) United States
(12) Patent Application Publication
(10) Pub. No.: US 2016/0196625 A1
(43) Pub. Date: Jul. 7, 2016

(54) GENERATION OF A DATA INPUT USER INTERFACE IN A PROCESSING DEVICE CONFIGURED TO GENERATE PROPERTY INSPECTION REPORTS

(71) Applicant: TAOS Jam Solutions LLC, Woodridge, IL (US)

(72) Inventors: Toby Lynn ADAMSON, Mokena, IL (US); Marc Gregory RATLIFF, wHEATON, IL (US)

(21) Appl. No.: 14/989,045

(22) Filed: Jan. 6, 2016

Related U.S. Application Data
(60) Provisional application No. 62/100,168, filed on Jan. 6, 2015.

(51) Int. Cl. G06Q 50/16; G06Q 10/10

(52) U.S. Cl. CPC G06Q 50/16; G06Q 10/10

(57) ABSTRACT

A processing device receives type data and location data for a property. The processing device determines a default status for a feature of the property based on the type data and location data. Thereafter, the processing device causes a data input user interface to be displayed, which data input user interface comprises an indication of the default status of the feature thus determined. The data input user interface may comprise a user-selectable input mechanism that permits the processing device to receive user input indicative of an actual status of the feature in question.

### CROSS-REFERENCE TO RELATED APPLICATION

The instant application claims the benefit of Provisional U.S. Patent Application Ser. No. 62/100,168 entitled “Automatically Default And Set Item Status In A Property Inspection Report Based On Modal Operator Of Possibility And Problems Found” and filed Jan. 6, 2015, the teachings of which are incorporated herein by this reference.

### FIELD

The instant disclosure relates generally to the generation of user interfaces in processing devices and, in particular, to the generation of a data input user interface in a processing device configured to generate property inspection reports.

### BACKGROUND

In most real estate property purchase transactions (including, but not limited to, residential and commercial real estate transactions), a property inspection is conducted after a contract is signed to purchase the property. The contract is typically contingent on the results of the property inspection among other provisions. The property inspection provision provides the buyer with the right to obtain a professional inspector to check the property for defects.

A property inspection report is typically used to communicate the findings of the inspection. Such reports typically provide information concerning the major functioning features of the property; for example, heating, ventilation and air conditioning (HVAC) systems, electrical systems, plumbing, etc. These reports include many sections including, but not limited to, sections on each feature in the house highlighting issues and observations, a description of the materials or specifications of a particular feature, a set of limitations of the inspection generally or by system and a summary page used to either highlight critical issues or serve as an outline of the full report.

Furthermore, such reports also typically reflect the status of items or features in the property. As used herein, an item or feature is a specific object, system or structural component that may be a constituent element of a given property such as, but not limited to, a particular appliance, a plumbing fixture, electrical equipment, roof covering, etc. In most circumstances, the report will include information concerning specific issues with features or reasons why a feature could not be inspected. The status of a given feature is based on the observations made about that feature as assessed according to the examiner's experience and discretion. For instance, the inspector may observe that a given feature of the property has an issue affecting its normal operation, which would result in a status indication of a more significant issue as opposed to, for example, a cosmetic issue like a scratch.

Various tools are currently available to assist in the production of property inspection reports. Generally, such tools comprise software programs capable of execution by one or more processing devices. Examples of such software-based, property inspection report generation tools include “INSPECTIT,” “HOME INSPECTOR PRO,” “3D INSPECTION SYSTEMS” and “HOMEGAUGE.” These programs operate, in part, by providing a data input user interface on a display of a suitable processing device, e.g., a portable computer or the like. These data input user interfaces typically comprise a long list of items based on a template that must be specifically defined by the user, i.e., the inspector. The inspector may create templates for different types of properties in different environments within the inspector's typical operating territory and based on their personal preferences, which templates must be maintained manually as the inspector learns more about these various environments. Regardless of the template used, these currently available tools assume either that a given feature isn't applicable to a given property unless a status is specifically set for that feature, or that a status for a feature is unknown until the inspector sets the status. These other programs also have no connection between the problems identified for a feature and the ultimate status of that feature. Further still, some of these programs force the user to further assign a significance to a problem in order to properly place the item in the report. In short, the status of a feature must be set explicitly by the inspector, which makes use of the data input user interface increasingly cumbersome, and the manner in which such status is displayed on the report is completely void of a relationship to the problems or observations made.

Thus, improvements in data input user interfaces of property inspection report generation tools would represent a welcome advancement in the art.

### SUMMARY

The instant disclosure describes generation of a data input user interface for use in property inspection report generation tools that addresses the shortcomings noted above. In particular, a processing device receives type data indicative of a property being inspected and further receives location data indicative of a location of the property. The processing device determines a default status for a feature of the property based on the type data and location data. Thereafter, the processing device causes a data input user interface to be displayed, which data input user interface comprises an indication of the default status of the feature thus determined. In an embodiment, the default status may comprise an indication of a likelihood of presence of the feature. Furthermore, the processing device may also receive environmental data and/or historical inspection data concerning the property according to the location data. In this case, the determination of the default status may comprise a determination of a likely condition of the feature based on the environmental data and/or historical inspection data. In practice, any of the data received by the processing device may be received from a user input device operatively connected to the processing device or from another processing device via a communication channel. Likewise, causing the data input user interface to be displayed may comprise the processing device displaying the data input user interface on a display operatively connected thereto, or sending data representative of the data input user interface to another processing device via a communication channel. Regardless, the data input user interface may comprise a user-selectable input mechanism that permits the processing device to receive user input indicative of an actual status of the feature in question.

### BRIEF DESCRIPTION OF THE DRAWINGS

The features described in this disclosure are set forth with particularity in the appended claims. These features will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a block diagram of a system comprising various processing devices in accordance with the instant disclosure;

FIG. 2 is a flowchart illustrating processing for the generation of a data input user interface in accordance with the instant disclosure; and

FIGS. 3-6 illustrate various examples of embodiments of a data input user interface in accordance with the instant disclosure.

### DETAILED DESCRIPTION OF THE PRESENT EMBODIMENTS

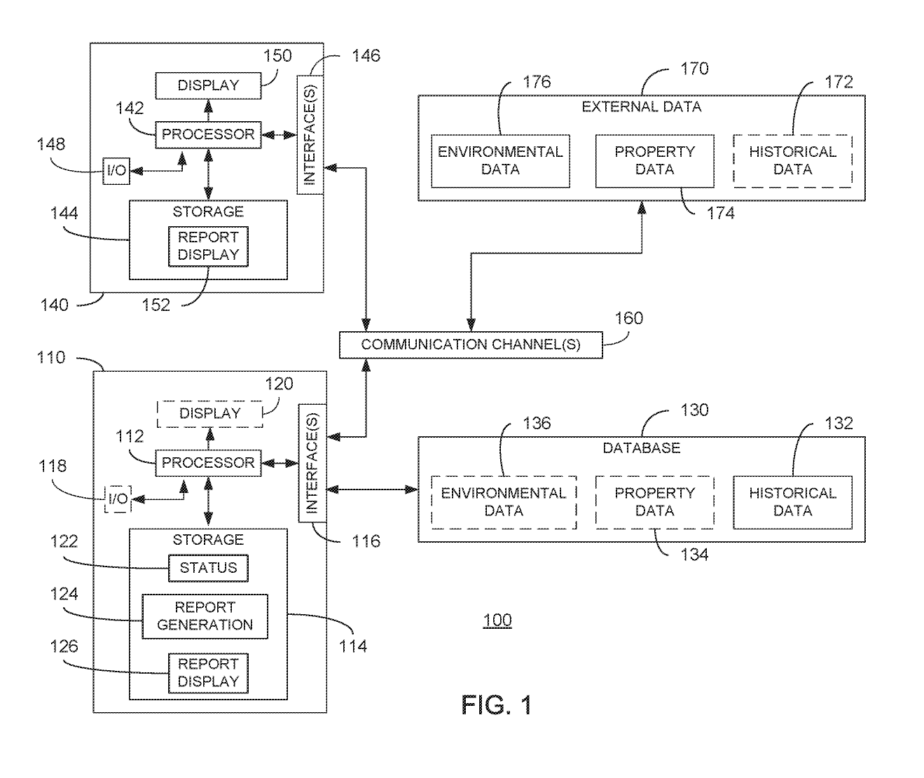

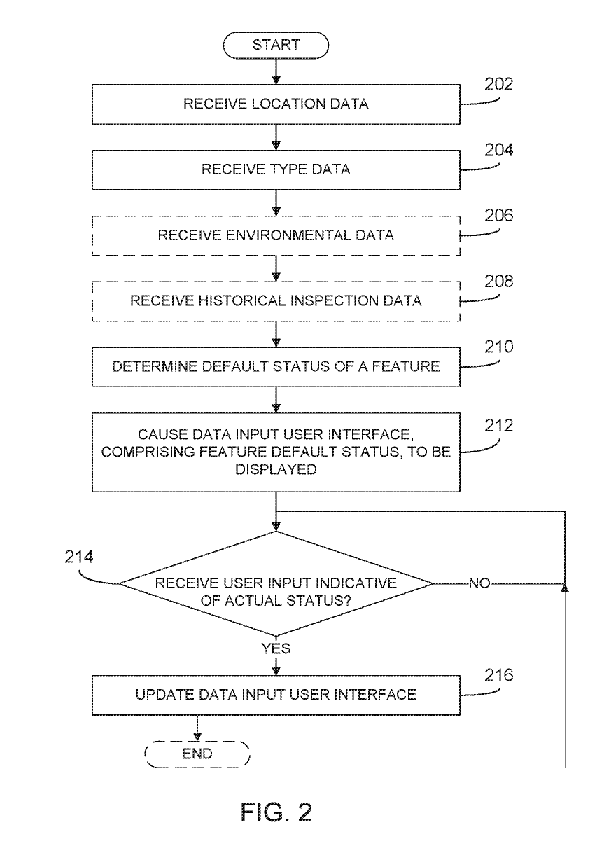

Referring now to FIG. 1, a system 100 comprising a (first) processing device 110 in accordance with the instant disclosure is illustrated. The processing device 110 may be used to implement, for example, processing in accordance with FIG. 2 and the various data input user interfaces as described in greater detail below. Regardless, the device 110 comprises a processor 112 coupled to a storage component 114. The storage component 114, in turn, comprises stored executable instructions 122-126 as well as data to be operated upon (not shown) in accordance with the executable instructions 122-126. In an embodiment, the processor 112 may comprise one or more of a microprocessor, microcontroller, digital signal processor, co-processor or the like or combinations thereof capable of executing the stored instructions 122-126 and operating upon the stored data 218. Likewise, the storage component 114 may comprise one or more devices such as volatile or nonvolatile memory including but not limited to random access memory (RAM) or read only memory (ROM). Further still, the storage component 114 may be embodied in a variety of forms, such as a hard drive, optical disc drive, floppy disc drive, etc. Processor and storage arrangements of the types illustrated in FIG. 1 are well known to those having ordinary skill in the art. In one embodiment, the processing techniques described herein are implemented as a combination of executable instructions and data within the storage component 114.

As shown, the processing device 110 may comprise communication interface(s) 116 and one or more optional user input and/or output (I/O) devices 118 in communication with the processor 112. The user I/O devices 118, when provided, may comprise any mechanism for providing user input to the processor 112 including, but not limited to, a keyboard, a mouse, a touch screen, a microphone and suitable voice recognition application or any other means whereby a user of the processing device 110 may provide input data to the processor 112. An optional display 120 may also be operatively connected to the processor 112 and may comprise any conventional display mechanism such as a cathode ray tube (CRT), flat panel display, or any other display mechanism. Additionally, the user I/O devices 118, when provided, may comprise any mechanism (in addition to the display 120) for providing output to a user of the processing device 110 including, but not limited to speakers, lights, tactile outputs, etc. In an embodiment, the display 120, in conjunction with suitable stored instructions 126, may be used to implement a graphical user interface. Techniques for the implementation of graphical user interfaces in this manner are well known to those having ordinary skill in the art.

The communication interface(s) 116 may include the hardware, firmware and/or software necessary for communication between the processor 112 and various peripheral devices, such as media drives (e.g., magnetic disk or optical disk drives), databases, other processing devices or any other input source used in connection with the instant techniques. Alternatively, or additionally, the communication interface(s) 116 may comprise hardware, firmware and/or software that allows the processor 112 to communicate with other processing devices via one or more communication channels 160. For example, the communication channel(s) 160 may comprise a wired or wireless network, whether local or wide area, private or public, or combinations thereof, as known in the art. For example, such networks may include the World Wide Web or Internet, a private enterprise network, a wireless cellular data network, etc. as known in the art.

As noted above, the storage device 114 may comprise executable instructions 122-126 that may be executed by the processor 112, thereby causing the processor 112 to perform, at a minimum, the various operations described herein. In particular, and as described in further detail below, the storage device 114 may comprise executable instruction 122 configured to determine status of a property feature based at least upon received type data and location data (as well as, optionally, received environmental data and/or historical inspection data). Furthermore, the storage device 114 may comprise executable instructions 124 configured to generate a property inspection report, including one or more data input user interfaces as described below, and configured, where applicable, to transmit data representative of a data input user interface to another processing device 140. Further still, the storage device 114 may comprise executable instructions 126 configured to cause the display of a property inspection report on the local display 120.

While the processing device 110 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the processing device 110 may include a greater or lesser number of components than those illustrated. Once again, those of ordinary skill in the art will appreciate the wide number of variations that may be used is this manner. Further still, the single processing device 110 described above may also be implemented as a combination of such processing devices configured to operate in conjunction (for example, using known networking techniques) to implement the teachings of the instant disclosure.

As further illustrated in FIG. 1, the system 100 may comprise one or more databases 130 operatively connected to the processing device 110 (via the communication interface 116) including, in the illustrated example, historical data 132, property data 134 and environmental data 136. Alternatively, one or more external data stores 170 in the form, for example, of one or more Web-based database servers or the like (whether private or publicly available), that may store historical data 172, property data 174 and environmental data 176. As shown in FIG. 1, the historical data 132 may be preferably stored on the database(s) 130 and optionally available from the external data source(s) 170, whereas both the property data 174 and environmental data 176 may be preferably stored at the external data source(s) 170 and optionally available from the database(s) 130.

As used herein, the property data 134, 174 preferably includes type data for one or more properties that may be inspected, which type data may include, but is not limited to: a type descriptor of the property (for example, “residential,” “commercial,” “industrial,” “single family,” “new construction,” “multi-unit,” etc.), numbers and types of rooms in the property, materials used for certain features of the property, vacancy status, mortgage status, etc. In practice, a number of commercially available data resources may be used to obtain the property data 134, 174 including, but not necessarily limited to, “REALTOR.COM,” “ZILLOW,” “HOMES.COM,” “REDFIN.COM” and multiple listing services (MLS). The historical data 132, 172 may comprise data concerning prior inspections performed on the property and/or other properties in the relevant neighborhood, city, county or state. The environmental data 136, 176 may comprise information concerning the particular environment of the property at varying degrees of specificity including, but not limited to: crime statistics, average climate data, local income levels, average property prices, local school performance, nearby zoning information, etc. As described below, the various constituent data types included in the historical data 132, 172, property data 134, 174 and environmental data 136, 176 may all contribute to a determination concerning a default status of various features of a given property.

FIG. 1 also illustrates another (or second) processing device 140 comprising a processor 142, storage component 144, communication interface(s) 146, user I/O devices 148 and display 150, substantially equivalent to processor 112, storage component 114, communication interface(s) 116, user I/O devices 118 and display 120 described above relative to first processing device 110. In an embodiment, the other processing device 140 operates remotely but in conjunction with the first processing device 110, for example, in a client-server fashion with the first processing device 110 operating as a property inspection report generation server and the other processing device 140 operating as a remote, data collection client. For example, in this embodiment, the other processing device 140 (which may be embodied as a portable computing device such as a tablet, smart phone, laptop computer, etc.) serves as a data input mechanism to the extent that it operates to receive user input (via its user I/O device 148, for example) and provide such input to the first processing device 110 that, in turn, provides data representative of a data input user interface (as described herein) back to the other processing device 140 for display on the display 150. To this end, the storage component 144 comprises executable instructions 152 that cause the processor 142 to display such data on the display 150 and further implement the data input user interface when necessary.

Referring now to FIG. 2, a flowchart illustrating processing in accordance with an embodiment of the instant disclosure is provided. Thus, at block 202, location data indicative of a location of a property being inspected is received by a processing device. As used herein, a processing device “receives” data to the extent that it is either provided to the processing device via a local data input mechanism (e.g., the user I/O devices 118 shown in FIG. 1) or via a communication channel from an external source (e.g., the other processing device 140, external data sources 170 or databases 130 shown in FIG. 1). Further still, data may be “received” by the processing device in response to a request by the processing device (i.e., “pulled” data) or irrespective of a specific request for the data (i.e., “pushed” data). Thus, for example, the location data received at block 202 may comprise a postal address of the property in question (e.g., state, county, town, street address and ZIP code) as entered by a user of the processing device via user input devices as described above. In another embodiment, the location data may be retrieved from a project management or calendar program having data maintained by the inspector and operating on another processing device. As will be appreciated by those having skill in the art, the location data may comprise any data useful in identifying a location of the property in question and may take forms other than a conventional postal address varying in specificity, such as, but not limited to latitude/longitude coordinates, tax identification number, neighborhood names, subdivision names, etc. Similarly, at block 204, the processing device receives type data indicative of a type of the property being inspected, which may include data indicative of type substantially equivalent the various examples described above. In short, the type data may include any data that may be used to assess the likely status of a potential feature of the property in question, including the likelihood that the feature is included in the property and, if so, its likely condition.

As further shown in FIG. 2, the processing device may optionally receive environmental data and/or historical inspection data at block 206 and block 208, respectively. In an embodiment, both the environmental data and the historical inspection data, if obtained, are based on the location data received at block 202. For example, where the location data comprises a ZIP code or the like, the location data may be used to access a database or other data source providing average and/or likely extreme climate conditions for that location. As another example, that same location data could be used to access a database or other data source providing recent crime statistics corresponding to that location.

At step 210, a default status for a feature of the property being inspected may be determined based at least upon the previously received type data and location data (and environmental and/or historical data if also received). Such information is useful to the extent that it may be used to predict the status of a certain feature of the property. In an embodiment, the determination of a default status for a given feature comprises assessing various facts about the property in question as represented by the type data and location data (and environmental data and/or historical data, if available) to determine the likely status of the feature, particularly the likelihood that the feature is included in the property and, if likely to be present, its expected condition. Table 1 below illustrates a form of a table that may be used to assess the various available factors.

TABLE 1

| Likelihood of a feature | | |
|---|---|---|
| existing in a property for | Likelihood of feature being | |
| which a given factor is true: | in satisfactory condition: | Default status: |
| Rarely or Sometimes | N/A | N/A |
| Usually or Always | Usually or Always | Satisfactory |
| Usually or Always | Rarely or Sometimes | N/A |

In this example, if a given factor for a property is true, the likelihood of the existence of a certain feature in that property is either “rarely or sometimes” or “usually or always.” Similar probability labels are also applied to the likelihood of the feature being in satisfactory condition only if the likelihood of the existence of the feature is “usually or always.” As further shown, if a feature is “rarely or sometimes” included in a given property for which the factor is true, then the default status is “N/A.” If the feature is “usually or always” included, and the feature is “usually or always” in satisfactory condition, then the default status of the feature is “Satisfactory,” whereas if it's “rarely or sometimes” in satisfactory condition, then the default status of the feature is “N/A,” indicating an indeterminate state requiring input from the user to resolve. In an embodiment, rules for each possible feature may be embodied in logic tables similar to Table 1. Further, such rules could be based on a combination of factors for the property, in which case each rule may be thought of as a number of conditions that, if satisfied, imply the likelihood of a given feature being present and/or that feature being in satisfactory condition. More formally, in an embodiment, each rule comprises an indicator specifying a particular aspect of location data and type data (and, optionally, environmental data and/or historical data) as well as an evaluation operator and an evaluation operand. A given rule corresponding to a feature evaluates positively (true) if the specified factors for a given property evaluate to true with the operator and operand. The feature is then assigned a specific likelihood of existing based on which of many sets of rules evaluate to true. In this manner, the factors for given property can be assessed against a number of rules for the various possible features such that any given set of factors that satisfies one or more rules results in one or more default statuses for those features corresponding to the satisfied rules.

Thus, implementing logic like that described above relative to Table 1, the default status for a given feature may be determined. For example, where the type and location data correspond to a property that is a residential, single family home located in the upper, Midwest of the United States, there may be an increased likelihood that the property includes a furnace in the basement as opposed to, for example, a residential, single family home located in the U.S. state of Florida where a heat pump is more likely located in the exterior of the property. As another example, a property located in a relatively hot, arid climate may be more likely to include an evaporative cooler unit as opposed to a compressor-type air conditioning unit, whereas the reverse is more likely for a property located in a more humid climate. In a further example of environmental data, if local crime statistics indicate a relatively high-frequency of break-ins in the area including the property in question, the property may be more likely to include a security system that is in satisfactory working condition. With respect to the historical inspection data, the location information can be used to identify whether any previously-established inspection reports exist for the property in question, thereby permitting data concerning the presence and/or condition of previously-identified features of the property to be leveraged in the generation of data input user interfaces for the current property inspection report. For example, if a previous inspection report indicates the prior presence of an enclosed porch in satisfactory condition for a given residential property, then it is more likely that the property still includes the enclosed porch currently. Alternatively, the historical data may include inspection data from other, nearby properties whereby trends about similar properties may be determined, e.g., the likely condition of certain features such as driveway aprons in a given a neighborhood. Further still, with regard to the enclosed porch example, if the type data indicates that the residential property is currently occupied, there is a likelihood that the enclosed porch remains in satisfactory condition.

Table 2 below illustrates another example for determining status of a feature based on a given factor, and further illustrating how an actual status of the feature may be determined in the absence of any further user input for that feature. In the example of Table 2, the property is assumed to be a residential, single family home and the feature status is based on the likelihood of that feature being present in a given type of room.

TABLE 2

| | | | Actual |
|---|---|---|---|
| Likelihood of a feature | | | status in |
| existing in a home for | Likelihood | | report if no |
| which a given factor is | of feature | Default | problems |
| true: | being in a room: | status: | reported: |
| Usually or Always | Rarely or | N/A | Satisfactory |
| | Sometimes | | |
| Rarely or Sometimes | Usually or Always | N/A | N/A |
| Usually or Always | Usually or Always | Satisfactory | Satisfactory |

In the example of Table 2, if a feature is “usually or always” found in the home and “rarely or sometimes” found in a given room in the home, then the default status is “N/A”, which converts to an actual status of “Satisfactory” if no problems are found with that feature; if the feature is “rarely or sometimes” found in the home and “usually or always” found in a given room in the home, then the default status is “N/A”, which remains “N/A” if no problems are found with that feature; and if the feature is “usually or always” found in the home and “usually or always” found in a given room in the home, then the default status is “Satisfactory”, which remains “Satisfactory” if no problems are found with that feature. As a real-world example, an electrical sub-panel may be “rarely or sometimes” located in a house and, when a sub-panel is in a house, it is “usually or always” found in a basement. In this case, with reference to Table 2, the default status for an electrical sub-panel is set to “N/A” which remains as “N/A” in a subsequent inspection report if the inspector does not override the default status, i.e., no sub-panel is found. As another example, a sink is “usually or always” found in a house and, when a sink is found in a house, it is “rarely or sometimes” found in a family room. In this case, with reference to Table 2, the default status for a sink set to “N/A,” which then converts to “Satisfactory” in the event that inspection and/or testing of the sinks in the house do not give rise to a need to alter the status to something other than “Satisfactory.” As yet another example, a refrigerator is “usually or always” found in a house and, when a refrigerator is found in a house, it is “usually or always” found in a kitchen. In this case, with reference to Table 2, the default status for a refrigerator is set to “satisfactory” which remains as “satisfactory” in a subsequent inspection report if no problems are found with the refrigerator.

Furthermore, it is appreciated that, in some circumstances, the default status of a given feature may depend on the fact that there are more than one instance of that feature in a given property, each instance of which may have its own concerns or issues that would affect the default status. For example, a given property may have more than one window, perhaps in different locations within the property. In this case, then, the default status of the “Windows,” as well as any actual status based on entered concerns, will be based on all available windows.

Regardless, by determining default statuses for various features in a property based on pre-inspection facts about the property, the need to continually update templates and/or to manually determine the status for each and every feature of a given property can be eliminated or at least minimized, thereby improving usability of the property inspection report generation tool.

Referring once again to FIG. 2, having determined a default status for a given feature of a property being inspected, processing continues at block 212 where the processing device causes a data input user interface, comprising the default status for the feature, to be displayed. As noted above, the data input user interface may be displayed on a local display for the processing device or, in a client-server embodiment for example, data representative of such a data input user interface may be sent to another processing device for display on a suitable device local to the other processing device. In an embodiment, the data input user interface may comprise one or more user-selectable input mechanisms that are configured to provide user input indicative of an actual status of the feature in question. Thus, at block 214 of FIG. 2, it is continually determined whether user input indicative of an actual status for the feature is received. If so, processing continues at block 216 where the data input user interface is updated to reflect the actual status of the feature. Thereafter, processing may end or continue once again at block 214 in the event that the actual status may be further updated. It is noted that, while FIG. 2 illustrates processing in accordance with the instant disclosure in the context of a single feature of a property, it is understood that the illustrated process can be (and, almost invariably will be) replicated for a significant number of features that may be present in a given property.

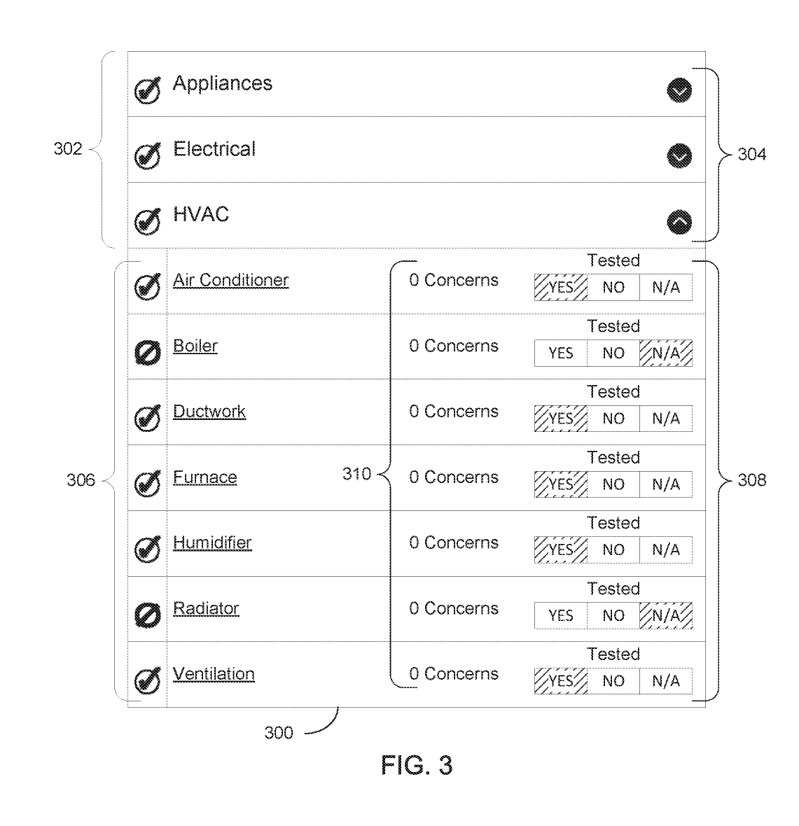

Examples of a data input user interface in accordance with the processing illustrated at blocks 212-216 of FIG. 2 are further illustrated in FIGS. 3-7. With reference to FIG. 3, a data input user interface 300 is shown comprising a number of general categories 302 labeled, in this case, “Appliances,” “Electrical” and “HVAC.” Each category includes an expand/collapse control 304 that permits further information concerning specific features within each category to be displayed. In this case, the “HVAC” category is expanded to reveal a number of features within that category, i.e., “Air Conditioner,” “Boiler,” “Ductwork,” “Furnace,” “Humidifier,” “Radiator” and “Ventilation.” Each feature thus displayed includes a default status indication 306 in which a check mark symbol indicates a “Satisfactory” status and a null symbol indicates a “N/A” status. Likewise, each feature also includes a status input control 308 and a concerns indication 310. In particular, each status input control 308 acts, in the illustrated embodiment, as a three-state toggle switch, the initial state of which is configured to reflect the default status of the corresponding feature. Thus, in the example of FIG. 3, the “Yes” input of the status input controls for the “Air Conditioner,” “Ductwork,” “Furnace,” “Humidifier” and “Ventilation” are highlighted indicating the default state of “Satisfactory,” as further shown by the corresponding default status indicators 306. However, as described in greater detail below, the other inputs of the status input controls 308 may be selected such that the inspector can modify the default status of each feature as desired. In the event that a feature has been tested and found to have an issue or concern, the concern indication 310 will illustrate the number of such concerns found. As further shown in FIG. 3, the label for each feature may be presented in the form of a user-selectable hyperlink (as indicated by the underlining) that permits a user to select the corresponding hyperlink to ascertain further information about that feature or to provide user input concerning that feature.

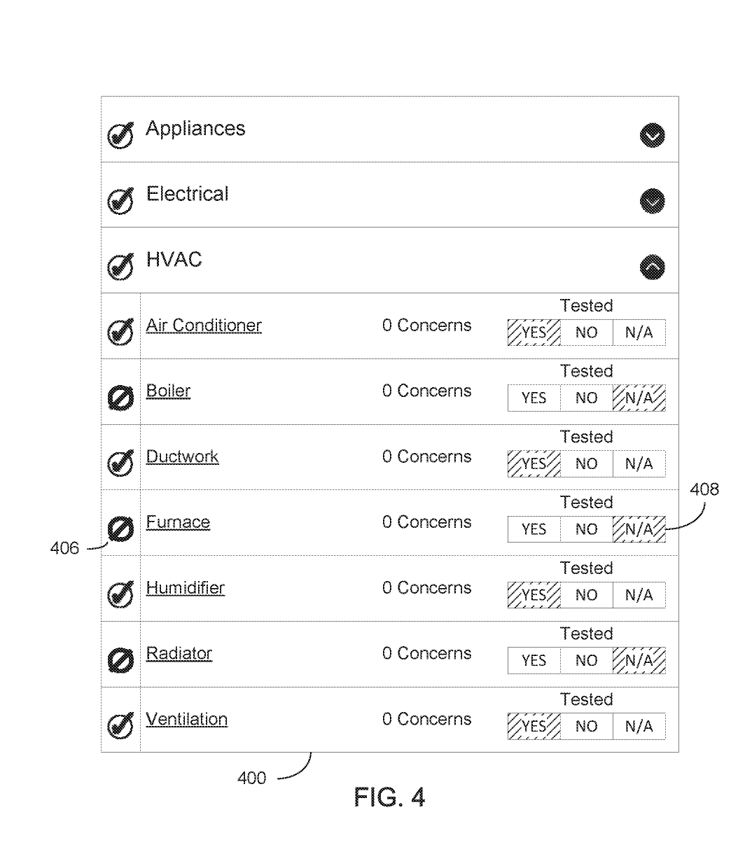

For example, if a user (inspector) discovers that a property in question does not have a furnace (despite the default status indication of “Satisfactory as shown in FIG. 3), the user can select the “N/A” input from the status input control 308 corresponding to the “Furnace.” As a consequence of this action, an updated data input user interface 400 as shown in FIG. 4 may be provided. As shown in FIG. 4, the “N/A” input 408 for the “Furnace” feature is now highlighted and a corresponding N/A status indicator 406 is also shown.

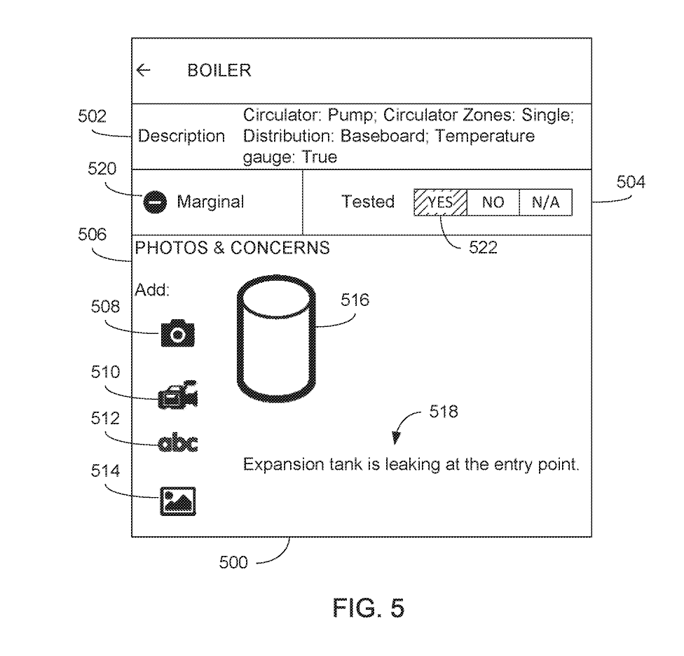

As a further example, if the user has conducted testing on the boiler of the property and found an issue or concern, the user can select the “Boiler” hyperlink and be provided with another data input mechanism 500 as shown in FIG. 5. In this case, the data input mechanism 500 comprises a feature description panel 510 comprising a textual description of the feature in question, in this case, a boiler for the property. A status panel 504 for that feature is also provide which includes the status inputs 522 as well as a status indicator 520. An input panel 506 is provide that includes various input mechanisms permitting the user to add data further describing any testing performed on the feature and/or concerns that the user has about that feature. For example, the input panel 506 includes user-selectable mechanisms 508-514. A photo input button 508 may be selected thereby permitting the user to upload one more photos of the feature in question. Similarly, a video input button 510 may be selected thereby permitting the user to upload one more videos of the feature in question. A text input button 512 is provided such that the user can enter a textual description concerning the condition of the feature. Additionally, a graphic input button 514 may be provided such that the user can upload a graphic concerning the feature in question. Techniques for implementing such uploading and data entry functionality of the type ascribed to the illustrated user-selectable mechanisms 508-514 are well known in the art and need not be described in further detail herein. In the illustrated example, a photo or graphic 516 concerning the boiler has been added by the user, along with a textual description 518 of the noted issue or concern.

Once information concerning the feature has been entered into the input panel 506, the status panel 504 is automatically updated. For example, in the illustrated example, the status indicator 530 is updated to reflect a “Marginal” status and the status input 522 and the status indicator 520 are also automatically updated as soon as any data is input in the input panel 506. An example of a mapping that may be employed to translate issues or problems noted with a given feature to a status indicator is illustrated in Table 3 below.

TABLE 3

| If the problem has significance of: | Status indicator should be: |
|---|---|
| Not working | Not working |
| Safety Concern | Safety Hazard |
| 1 or more possible major concerns | Marginal |
| 1 or more minor concerns | Satisfactory |
| 1 or more moderate concerns | Marginal |
| 1 or more major concerns | Poor |
| 1 more symptoms of possible concern | Satisfactory |
| Old with no other problems | Satisfactory |
| Old with 1 or more other problems | Status based on other problems |
| Cosmetic | Satisfactory |

It is noted that the mapping illustrated in Table 3 is for illustrative purposes only and those having ordinary skill in the art will appreciate that other mappings could be equally employed.

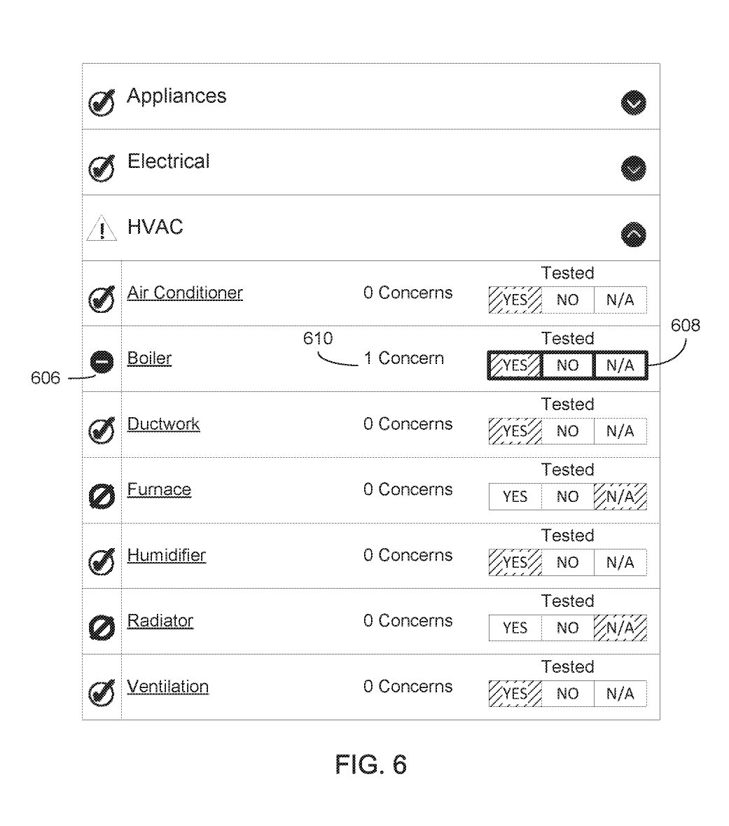

Upon completing entry of the noted concern via the data input mechanism 500, the user is presented with an updated data input user interface 600 (FIG. 6) that reflects the actual status that the user has a concern about the boiler as indicated by the negative symbol status indicator 606 and the concern indication 610. Furthermore, in this case, the updated status input control 608 reflects not only the updated status of “Yes,” but also includes further highlighting (bolded lines in the illustrated example) to further call the user's attention to the fact that an issue has been noted with respect to the boiler. It is noted that, while only a few examples of status indicators 306, 406, 606 have been described above, those having skill in the art will appreciate that other symbols indicative of different statuses may be equally employed.

While particular preferred embodiments have been shown and described, those skilled in the art will appreciate that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. In a processing device configured to generate property inspection reports, a method for generating a data input user interface, the method comprising:
receiving, by the processing device, location data indicative of a location of a property being inspected;
receiving, by the processing device, type data indicative of a type of the property;
for a feature of the property, determining, by the processing device, a default status of the feature based on the type data and the location data; and
causing, by the processing device, the data input user interface to be displayed, the data user input user interface comprising an indication of the default status of the feature of the property being inspected.

2. The method of claim 1, wherein determining the default status further comprises determining likelihood of presence of the feature based on the type data and the location data.

3. The method of claim 1, further comprising:
receiving, by the processing device, environmental data based on the location data,
wherein determining the default status comprises determining likely condition of the feature based on the environmental data.

4. The method of claim 1, further comprising:
receiving, by the processing device, historical inspection data based on the location data,
wherein determining default status comprises determining likely condition of the feature based on the historical inspection data.

5. The method of claim 1, wherein receiving the type data and the location data further comprises receiving the type data and the location data from a user input device operatively connected to the processing device.

6. The method of claim 1, wherein receiving the type data and the location data further comprises receiving the type data and the location data from another processing device via a communication channel.

7. The method of claim 1, wherein causing the data input user interface to be displayed comprises displaying the data user input user interface on a display operatively connected to the processing device.

8. The method of claim 1, wherein causing the data input user interface to be displayed comprises sending data representative of the data input user interface to another processing device via a communication channel.

9. The method of claim 1, wherein the data input user interface comprises a user-selectable input mechanism, the method further comprising:
receiving user input via the user-selectable input mechanism indicative of an actual status of the feature.

10. An apparatus configured to generate property inspection reports and generate a data input user interface, the apparatus comprising:
a processor; and
memory operatively connected to the processor, the memory comprising executable instructions that when executed by the processor cause the processor to:
receive location data indicative of a location of a property being inspected;
receive type data indicative of a type of the property;
for a feature of the property, determine a default status of the feature based on the type data and the location data; and
cause the data input user interface to be displayed, the data user input user interface comprising an indication of the default status of the feature of the property being inspected.

11. The apparatus of claim 10, wherein those executable instructions that cause the processor to determine the default status are further operative to cause the processor to determine likelihood of presence of the feature based on the type data and the location data.

12. The apparatus of claim 10, the memory further comprising executable instructions that, when executed by the processor cause the processor to:
receive environmental data based on the location data,
wherein those executable instructions that cause the processor to determine the default status are further operative to determine likely condition of the feature based on the environmental data.

13. The apparatus of claim 10, the memory further comprising executable instructions that, when executed by the processor cause the processor to:
receive historical inspection data based on the location data,
wherein those executable instructions that cause the processor to determine the default status are further operative to determine likely condition of the feature based on the historical inspection data.

14. The apparatus of claim 10, further comprising:
a user input device operatively connected to the processor,
wherein those executable instructions that cause the processor to receive the type data and the location data are further operative to receive the type data and the location data from the user input device.

15. The apparatus of claim 10, further comprising:
a network communication interface operatively connected to the processor,
wherein those executable instructions that cause the processor to receive the type data and the location data are further operative to receive the type data and the location data from another processing device via network communication interface.

16. The apparatus of claim 15, wherein those executable instructions that cause the processor to cause the data input user interface to be displayed are further operative to send data representative of the data input user interface to the other processing device via the network communication interface.

17. The apparatus of claim 10, further comprising:
a display operatively connected to the processor,
wherein those executable instructions that cause the processor to cause the data input user interface to be displayed are further operative to display the data input user interface on the display.

18. The apparatus of claim 10, wherein the data input user interface comprises a user-selectable input mechanism operative to provide user input indicative of an actual status of the feature.
